(19) United States
(12) Patent Application Publication
(10) Pub. No.: US 2010/0107323 A1
(43) Pub. Date: May 6, 2010

(54) Device With An Electric Field Sensor, Control Circuitry, And A Solenoid

(75) Inventor: David Charles Edelmann, Sidney, OH (US)

Correspondence Address: WOOD, HERRON & EVANS, LLP, 2700 CAREW TOWER, 441 VINE STREET, CINCINNATI, OH, 45202, US

(73) Assignee: Midmark Corporation, Versailles, OH (US)

(21) Appl. No.: 12/262,916

(22) Filed: Oct. 31, 2008

(51) Int. Cl. A61C 17/14; G01R 27/26; A61C 19/00

(52) U.S. Cl. 4/263; 324/661; 433/27

(57) ABSTRACT

A device such as a dental cuspidor or a dental delivery unit, with an electric field sensor, control circuitry, and a solenoid. The control circuitry is in electronic communication with the electric field sensor, and the solenoid is in electronic communication with the control circuitry. The electric field sensor has capacitive sensing and is operable to detect a change in capacitance. The control circuitry is operable to receive a signal from the electric field sensor indicative of a detected change in capacitance. The control circuitry is operable to actuate the solenoid in response to receiving the signal from the electric field sensor. A method is also provided.

### FIELD OF THE INVENTION

This invention relates generally to devices, and more specifically to dental devices.

### BACKGROUND OF THE INVENTION

Conventional dental operatories generally include an articulating dental chair for supporting a patient in a variety of positions to facilitate the performance of dental procedures and operations. For example, dental chairs are generally adapted to be raised and lowered relative to a floor surface, and to be moved between a first orientation where a seat back is inclined relative to a seat base to support the patient in a seated position, and a second orientation where the seat back is reclined to support the patient in a generally supine position.

The dental operatory may also include a dental delivery unit adapted to support various instruments and tools used during the performance of dental procedures. The delivery unit is typically provided with water and pressurized air for operating the instruments, and may include a tray for supporting instruments or other articles used by the practitioner. The delivery unit may be supported on a movable arm that facilitates positioning the unit and instruments adjacent the dental chair for convenient access by the practitioner during the performance of a procedure, then moved away to permit the patient to exit the dental chair when the procedure is complete.

Conventional dental operatories may further include a cuspidor provided adjacent the dental chair to permit patients to expel the contents of their mouths during or at the conclusion of the dental procedure, an adjustably positionable lamphead to illuminate the treatment area, and various other devices useful for the performance of dental procedures. Such devices may be supported on cabinetry or other structure positioned adjacent the dental chair for convenient access by the patient or the dental practitioner.

For instance, in operation, the dentist may initiate a dispense water function of the dental cuspidor to fill a cup with water for a dental patient. The dental patient may drink the water in the cup to rinse out his or her mouth. The patient may then spit out the water into a bowl of the dental cuspidor. To rinse the bowl, the dentist may initiate another dispense water function of the dental cuspidor to rinse out the bowl. Alternatively, the dental patient may initiate the dispense water functions to fill up the cup and rinse the bowl.

One drawback with contemporary systems is that some of the devices (e.g., dental cuspidors, etc.) on the dental operatories utilize membrane type buttons, springs, and other mechanical components to initiate the execution of a function of the device. However, these buttons, for example, often allow the ingress of fluids and debris such as dust and other particles or even fluids into the device, which in turn interfere with the function of the device by interfering with the air pressure that activates the springs. The interference often leads to variations and inconsistency in results.

For instance, although the dental cuspidor may be set up to fill a cup of a certain size with water such that subsequent cups of the same size can be filled in a similar manner, often, debris may enter the dental cuspidor, block the system, and cause variations in the amount of water that is dispensed. As such, some cups may be overfilled while others may be under filled. Moreover, often times a user may have to waste time and money seeking professional assistance (e.g., from the manufacturer) or replacing the dental cuspidor because of the debris.

Thus, new ways to operate devices, including dental devices, which improve the operational consistency of devices are needed; otherwise, users may continue to be hampered in their ability to maximize the use of their devices.

### SUMMARY OF THE INVENTION

The invention addresses these and other problems associated with the prior art by providing a device such as a dental cuspidor or a dental delivery unit, with an electric field sensor, control circuitry, and a solenoid. The control circuitry is in electronic communication with the electric field sensor, and the solenoid is in electronic communication with the control circuitry. The electric field sensor has capacitive sensing and is operable to detect a change in capacitance. The control circuitry is operable to receive a signal from the electric field sensor indicative of a detected change in capacitance. The control circuitry is operable to actuate the solenoid in response to receiving the signal from the electric field sensor.

As such, those of ordinary skill in the art may appreciate that variations and other inconsistencies may be reduced because of the electronic communication between the components. Furthermore, the electric field sensor, the control circuitry, and the solenoid may facilitate use of the device by a user because a simple touch may initiate a desired function of the device, and input members that reduce the ingress of debris and fluids may be utilized to initiate the function.

In some embodiments, the device may comprise an electric field sensor having capacitive sensing and operable to detect a change in capacitance. The device may also include control circuitry in electronic communication with the electric field sensor, with the control circuitry operable to receive a signal from the electric field sensor indicative of a detected change in capacitance. The device may also include a solenoid in electronic communication with the control circuitry. The control circuitry is operable to actuate the solenoid in response to receiving the signal from the electric field sensor.

In some embodiments, the dental cuspidor may comprise at least one electric field sensor having capacitive sensing and operable to detect a change in capacitance. The electric field sensor is associated with a water dispensing function of the dental cuspidor. The electric field sensor may comprise a first layer, including an input member operable for controlling the water dispensing function of the dental cuspidor. The capacitance change is generated when the first input member is touched. The sensor may also include an electric field sensor layer disposed below the first layer.

The dental cuspidor may also include control circuitry in electronic communication with the electric field sensor, the control circuitry operable to receive a signal from the electric field sensor indicative of a detected change in capacitance. Additionally, the dental cuspidor may also include a solenoid in electronic communication with the control circuitry. The control circuitry is operable to actuate the solenoid in response to receiving the signal from the electric field sensor. The dental cuspidor may also include a valve coupled to the solenoid. The solenoid opens or closes the valve in response to actuation of the solenoid by the control circuitry. The dental cuspidor may also include a water dispenser coupled to the valve. The water dispenser operable to dispense water in response to the opening or closing of the valve by the solenoid.

In some embodiments, the dental delivery unit may comprise at least one electric field sensor having capacitive sensing and operable to detect a change in capacitance. The electric field sensor is associated with a brake release function of the dental delivery unit. The electric field sensor may comprise a first layer, including an input member operable for controlling the brake release function of the dental delivery unit. The capacitance change is generated when the input member is touched. The sensor may also include an electric field sensor layer disposed below the first layer.

The dental delivery unit may also include control circuitry in electronic communication with the electric field sensor, where the control circuitry is operable to receive a signal from the electric field sensor indicative of a detected change in capacitance. Additionally, the dental delivery unit may also include a solenoid in electronic communication with the control circuitry. The control circuitry is operable to actuate the solenoid in response to receiving the signal from the electric field sensor. The dental delivery unit may also include a valve coupled to the solenoid. The solenoid opens or closes the valve in response to actuation of the solenoid by the control circuitry. The dental delivery unit may also include a brake coupled to the valve. The brake is operable to release in response to the opening or closing of the valve by the solenoid.

The invention also addresses problems associated with the prior art by providing a method for operating the device that provides an input member for the device that controls a function of the device, and provides a capacitive field proximate to the input member. The method for operating the device may also sense a capacitive change in the capacitive field caused by the touch of a user, and in response to the capacitive change, actuates the solenoid to perform the function.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there are described exemplary embodiments of the invention.

### BRIEF DESCRIPTION OF THE DRAWINGS

The accompanying drawings, which are incorporated in and constitute a part of this specification, illustrate embodiments of the invention and, together with a general description of the invention given above and the Detailed Description given below, serve to explain the invention.

FIG. 1 is a diagrammatic representation of one embodiment of a device consistent with the principles of the present invention.

FIG. 2 is a perspective view of an embodiment of a dental cuspidor consistent with the principles of the present invention.

FIG. 3 shows a detailed portion of the electric field sensors of the dental cuspidor of FIG. 2.

FIG. 4 is a cross sectional view of the dental cuspidor of FIG. 2.

FIG. 5 shows a detailed portion of the solenoids of the dental cuspidor of FIG. 4.

FIG. 6 is a perspective view of an embodiment a dental delivery unit consistent with the principles of the present invention.

FIG. 7 is a partial bottom elevation view of the dental delivery unit of FIG. 6.

FIG. 8 is a flowchart showing a method for operating the device of FIG. 1 consistent with the principles of the present invention.

### DETAILED DESCRIPTION

The invention addresses the problems with the prior art by providing a device such as a dental cuspidor or a dental delivery unit, with an electric field sensor, control circuitry, and a solenoid. The control circuitry is in electronic communication with the electric field sensor, and the solenoid is in electronic communication with the control circuitry. The electric field sensor has capacitive sensing and is operable to detect a change in capacitance. The control circuitry is operable to receive a signal from the electric field sensor indicative of a detected change in capacitance, and the control circuitry is further operable to actuate the solenoid in response to receiving the signal from the electric field sensor. A method is also provided herein.

In one embodiment, the device is in the form of a dental cuspidor. In another embodiment, the device in the form of a dental delivery unit. However, although the device may be in the form of a dental cuspidor or a dental delivery unit, the invention is not limited, and devices may include dental and/or medical devices, for example, with an electric field sensor, control circuitry, and a solenoid. Moreover, those of ordinary skill in the art will appreciate that the principles of the present invention may be utilized, for example, to replace a membrane button, to replace a switch, etc. in a device.

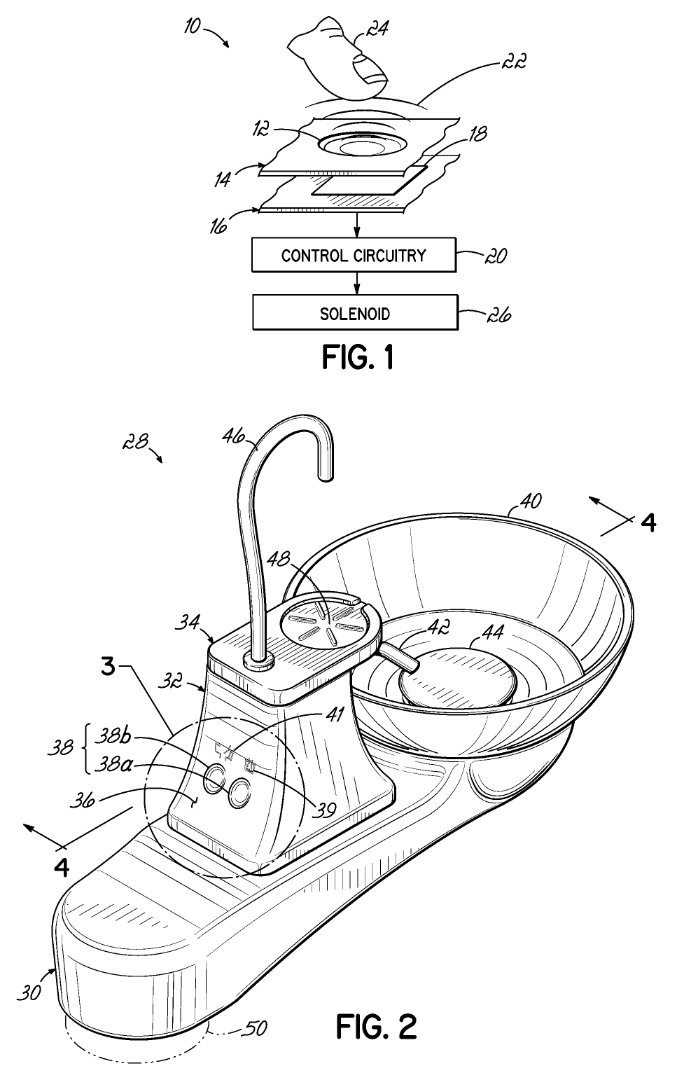

Turning now to the drawings, wherein like numbers denote like parts throughout the several views, FIG. 1 generally illustrates a device 10 for implementation of the invention. In the device 10, an input member 12 is positioned on a first layer 14 that sits over an electric field sensor layer 16. The electric field sensor layer 16 contains an electric field sensor 18 that is positioned beneath the input member 12 and is operably coupled to control circuitry 20 in the device 10.

Specifically, the electric field sensor 18 generates electric field 22 proximate the input member 12, such as above the input member 12 in first layer 14. When a user's finger 24 touches the input member 12, the electric field 22 above that member 12 is disrupted. The user's finger 24 causes a change in the capacitance which causes a change in the electric field 22, and the change is detected by the electric field sensor 18 in the electric field sensor layer 16 and electrically communicates the change to the control circuitry 20. Next, the control circuitry 20 may actuate a solenoid 26, which ultimately leads to the performance of the function associated with the input member 12.

In some embodiments, device 10 may have more than one of the input member 12, which may control similar functions or different functions. Moreover, a processor, or other processing circuitry, may be coupled to the control circuitry 20. Those of ordinary skill in the art may also appreciate that it may be beneficial to create first layer 14 with a material that may be easily cleaned and/or that does not allow the ingress of fluids or other debris into the device 10. Furthermore, those of ordinary skill in the art may appreciate that the human body acts as a ground causing the change in capacitance by disrupting the electric field 22, which is detected by the electric field sensor 18. Moreover, users may often times wear medical gloves or another barrier, and the electric field sensor 18 may nonetheless be able to sense a change in capacitance.

FIG. 2 illustrates a dental cuspidor 28 that may be utilized by a doctor, a dentist, a dental hygienist, a dental employee, a dental patient, etc, which may employ the touch switches described in relation to FIG. 1. The dental cuspidor 28 has a base portion 30, a middle portion 32 coupled to the base portion 30, and a platform portion 34 coupled to the middle portion 32. The middle portion 32 has a first layer 36 on an external surface of the middle portion 32 with at least one input member 38 (e.g., an input member 38a and/or an input member 38b). The first layer 36 may consist of an injectable plastic.

A user may utilize the input members 38a, 38b to control different functions of the cuspidor 28. A symbol 39 proximate input member 38a may indicate that this input member controls the function of filling a cup (not shown). A symbol 41 proximate input member 38b may indicate that this input member controls the function of rinsing bowl 40. Other control functions may also be provided. Each of the input members 38a, 38b may be a depression (e.g., a circular depression, a square depression, a rectangular depression, etc.), etc. in first layer 36. In other embodiments, the input members may be flush with the first layer 36 forming a smooth surface. The input members 38a, 38b may each generally have a flat, smooth surface that may be easily cleaned. Moreover, although two input members are illustrated, other embodiments may have more or fewer input members.

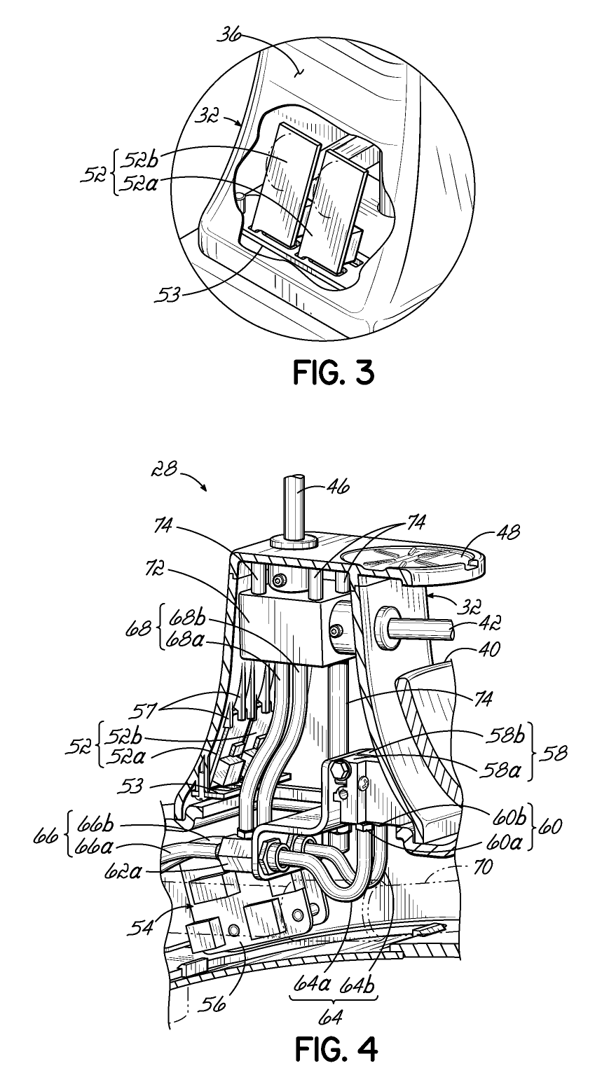

The middle portion 32 has a water dispenser 42, such as a spigot, to rinse the bowl 40 with water. The water drains out of the bowl 40 via drain mechanism 44. The platform portion 34 has a second water dispenser 46 used to fill a cup placed on cup holder 48 of the platform portion 34 with water. The dental cuspidor 28 may be attached to a dental operatory via attachment 50 (shown in phantom). The components interior to the base portion 30 and the middle portion 32 will be discussed further in connection with FIGS. 3-5.

Referring now to FIG. 3, each of the input members 38a, 38b (shown in FIG. 2) may be associated with a corresponding electric field sensor 52a, 52b. Specifically, the input member 38a for filling the cup has the electric field sensor 52a associated with it, and the input member 38b for rinsing the bowl 40 has the electric field sensor 52b associated with it. The electric field sensors 52a, 52b are interior to the first layer 36 of the middle portion 32, and may generally reside behind the input members 38a, 38b. The electric field sensors 52a, 52b are supported internally via supporting structure 53. The electric field sensors 52a, 52b may be, for example, QTouch QT100 sensors from Quantum Research Group, or alternatively, the QT100A sensors from Atmel Corporation.

In accordance with one aspect of the invention, the electric field sensors 52a, 52b may each provide a capacitive field proximate to the input members 38a, 38b in first layer 36. Specifically, the electric field sensors 52a, 52b may each include a copper surface over which the electrical field is generated. The electric field sensors 52a, 52b may also be equipped with capacitive sensing, which may be used to indicate that the corresponding input member has been touched by a user, such as by the finger of a user. A capacitance change will occur when either one of the input members 38a, 38b is touched, and the associated electric field sensor 52a, 52b detects the change in capacitance.

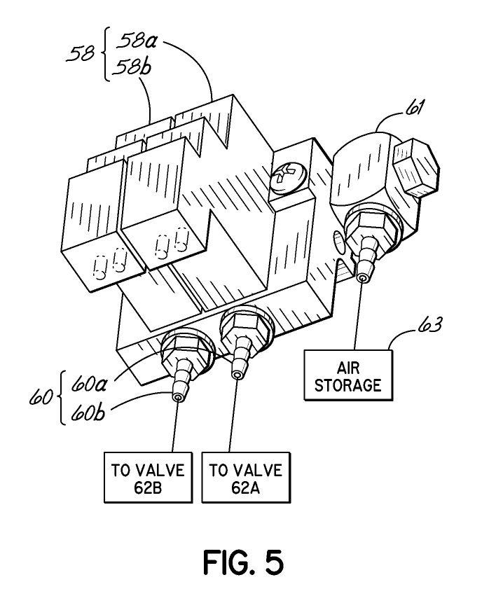

Turning to FIG. 4 and FIG. 5, after one of the electric field sensors 52a, 52b senses that a particular input member 38a, 38b (shown in FIG. 2) has been touched, the sensor may send a signal to control circuitry 54, which may be implemented on a printed circuit board (PCB) 56. Of note, the electric field sensors 52a, 52b may also include resistors, capacitors and other electrical components to send the signal, generate the electric field, and/or detect the change in capacitance. The electric field sensors 52a, 52b may also include the appropriate wiring and connectors for wire harnesses, and may be attached to cuspidor 28 via attachments 57.

Generally, when the object is present in the capacitive field that is in contact with ground, the corresponding electric field sensor 52 recognizes the difference in the electric field between that electric field sensor 52 and ground and that electric field sensor 52 is activated. When that electric field sensor 52 is activated, it sends a signal to control circuitry 54 requesting it to turn on the appropriate solenoid 58 (e.g., solenoid 58a and/or solenoid 58b). Indeed, the control circuitry 54 may utilize transistor circuits to send electrical current to the appropriate solenoid 58, which moves a spool to open the corresponding valve 60 (e.g., valve 60a and valve 60b). The solenoid 58a, which may be used for filling the cup, opens valve 60a while solenoid 58b, which may be used for rinsing bowl 40, opens valve 60b.

The valves 60a, 60b release system air from air introduce through storage valve 61 (seen in FIG. 5), which receives air from air storage 63 (in FIG. 5). The air then flows through valves 60a, 60b to the corresponding valves 62 (e.g., valve 62a and valve 62b). The valve 62a is actuated from the air and is used for dispensing water to fill the cup, and valve 62b (not shown in FIG. 4) is actuated from the air and is used for rinsing bowl 40. The air from valves 60a causes valve 62a to open, while the air from valve 60b causes valve 62b to open. The air travels to valves 62a, 62b via tubing 64a, 64b. The valve 62a receives air from tubing 64a while the valve 62b receives air from tubing 64b.

Tubing 66 and 68 may be utilized to carry water to the corresponding water dispensers 46, 42. Specifically, tubing 66a and 68a carry water to dispenser 46 while tubing 66b and 68b carry water to dispenser 42 to rinse bowl 40. Water from bowl 40 may exit cuspidor 28 through drainpipe 70 (shown in phantom). Additionally, a protective portion 72 may be utilized as internal support for the components of dental cuspidor 28, and to protect the connections of tubing 68a, 68b with dispensers 46, 42. Supporting structures 74 may also provide internal support for the dental cuspidor 28 and its components.

The valves 60a, 60b may be three-way valves that are normally closed. Actuation of one of the solenoids 58a, 58b by control circuitry 54 opens the corresponding valve 60a, 60b, but once actuation of that valve 60a, 60b ceases, the air stops. Indeed, the control circuitry 54 may be operable to actuate the solenoids 58a, 58b for as long as the corresponding electric field sensor 52 detects the change in capacitance. Thus, the valves 60a, 60b are responsive to the control circuitry 54 and once actuating stops, the valves 60a, 60b may close.

The valves 62a, 62b may be pilot air valves or other type of valves. Moreover, the pilot-operated valves may be water valves that are normally closed two-way valves that require a pilot signal to open. Additionally, although dental cuspidor 28 has been generally described as having an input member 38, an electric field sensor 52, and a solenoid 58 with a valve 60 for each function, a single solenoid may be utilized with more than one electric field sensor 52 in some embodiments.

In some embodiments, the electric field sensors 52 may be integral with a printed circuit board (“PCB”) 56, including a copper surface over which the electrical field is generated. When an object is present in this field that is in contact with ground, the electric field sensor 52 recognizes a change in the electric field and activates. Moreover, when the electric field sensor 52 is activated, it sends a signal to a controller PCB requesting it to open the appropriate valve 60. A transistor circuit may be used to send an electrical current, which moves a spool in the solenoid 58 and opens the valve 60. Indeed, those of ordinary skill in the art may appreciate that various modifications may be made to the structure and functionality consistent with the principles of the present invention.

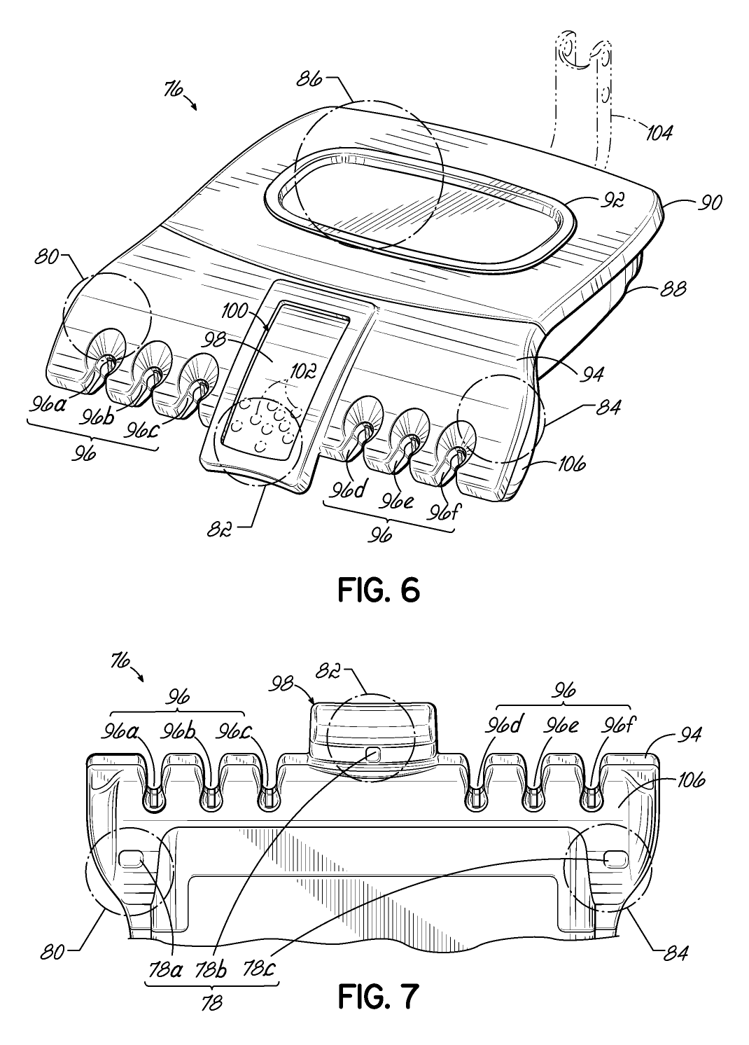

Before turning to FIG. 6 and FIG. 7 for the dental delivery unit, it is worth noting that additional functionality may be performed via the electric field sensor 52, control circuitry 54, and solenoid 58 for a device, such as a dental cuspidor 28. For example, there may be two circuits in the dental cuspidor, one to fill a cup with water, and one to rinse the bowl with water. There may be a microprocessor on the control circuitry 54 (e.g., controller PCB) used to control the amount of time to keep each solenoid valve open. To that end, there may be a push button switch or another electric field sensor on the dental cuspidor's control circuitry 54 (e.g., controller PCB) that is used in conjunction with the electric field sensor 52 and microprocessor to program this length of time. Indeed, the control circuitry 54 may be operable to actuate the solenoid 60 for as long as the change in capacitance is detected by the electric field sensor 52, and that length of time may be determined and reused. As such, a user may be able to contact the fill cup input member 38a (shown in FIG. 1) and have the cuspidor 28 fill a different cup for the same length of time without having to touch the input member 38a for that length of time. Moreover, the user may be able to more easily change the length of time if he or she starts using a different size cup, for example, by contacting the input member 38a for the new length of time.

Turning now to FIG. 6, this figure illustrates a dental delivery unit 76 that includes three electric field sensors 78 (shown in FIG. 7), specifically, sensor 78a in area 80, sensor 78b in area 82, and sensor 78c in area 84. The dental delivery unit 76 may also include control circuitry (not shown), and a solenoid (not shown) in area 86, to release a brake (not shown).

The dental delivery unit 76 may be utilized to hold instruments such as dental instruments and/or associated materials. The dental delivery unit 76 has a base portion 88, a top portion 90 with a tray 92, and a sloping portion 94 with at least one instrument holder 96 (e.g., holders 96a-96e) and a touchpad 98.

The touchpad 98 may include a screen 100 (e.g., a three and a half inch LCD display) and at least one button 102. The touchpad may provide information about an apparatus that is coupled to (e.g., coupled directly to, coupled indirectly such by being in the same dental operatory, etc.) the dental delivery unit 76 such as an instrument in one of the instrument holders 96, a dental chair associated with the dental delivery unit 76, a light associated with dental delivery unit 76, other apparatuses in the dental operatory, etc. Apparatuses may also include dental devices such as the dental cuspidor, the dental delivery unit, etc. Moreover, the buttons 102 may be used to navigate the screen 100 and/or may control the function of the apparatus such as to lower the chair, raise the chair, etc. Attachment 104 (in phantom) may be utilized to attach the dental delivery unit 76 to another apparatus like the dental chair.

As illustrated in FIG. 7, input members 78a, 78b, and 78c are located beneath the sloping portion 94 in bottom portion 106. Input member 78a is generally in area 80, input member 78b is generally in area 82 beneath touchpad 98, and input member 78c is generally in area 84. Each of the input members 78a, 78b, and 78c may have an electric field sensor and an electric field associated with it. Although three input members are illustrated, in some embodiments, fewer than three or more than three input members may be utilized.

The dental delivery unit 76 may normally be in a braked state, and when a user touches any one of the input members 78a, 78b, and 78c, the electric field sensor of the corresponding input member detects the change in capacitance, and the brake release function is initiated. As all the input members seek to initiate the brake release function, a single solenoid may be utilized to open or close a valve of the brake.

In a particular embodiment, for example, the dental delivery unit 76 may have three electric field sensors (not shown) that may be used to release a flex arm brake. Any one of them may request the control circuitry (e.g., controller PCB) to open the flex arm brake's solenoid valve, which sends a pilot signal to a normally open three-way valve. The flex arm brake may be activated with a pneumatic piston and the piston may normally be pressured with system air. The three-way valve may then be used to shut-off and relieve system air to the piston. In this system, the solenoid valve may be energized for however long the electric field sensor is activated.

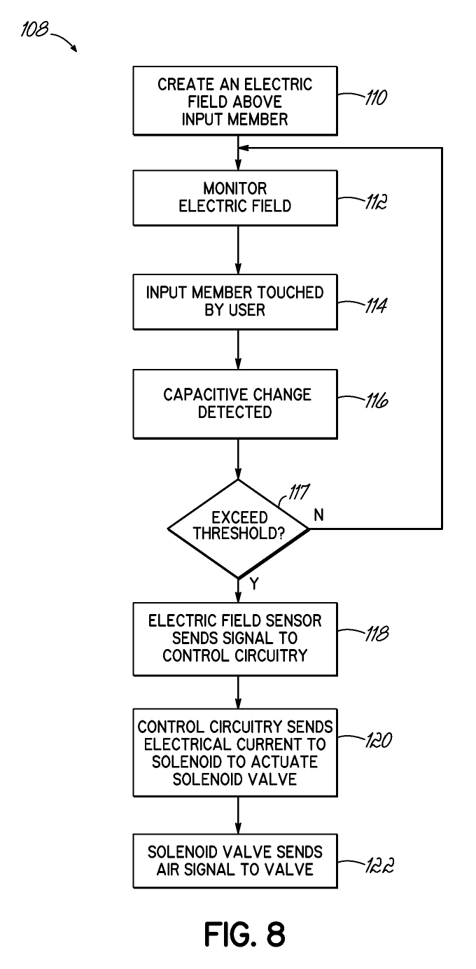

Referring now to FIG. 8, a method of operating a device, in accordance with the invention, may involve a methodology that prevents inadvertent triggering of the electric field sensors. As shown in the flowchart 108, an electric field, in some embodiments, is created above an input member by an electric field sensor as noted in block 110. The electric field sensor monitors the electric field as noted in block 112. When a user touches the input member (block 114), the user, having a different dielectric constant than air, causes a change in the capacitance. This capacitive change is detected by the electric field sensor (block 116). The capacitive change detected by the electric field sensor is electrically communicated to the control circuitry and sends a signal to the control circuitry as noted in block 118.

The control circuitry may be configured to check the capacitive change detected by the electric field sensor against a threshold value (block 117), for example, to ignore inadvertent contact. For instance, there may be a capacitance change level threshold that may be utilized to determine if there is an engagement of the input member by a user, i.e., when the change level exceeds the threshold. Alternatively, there may be a time threshold to determine if the capacitance change exists for a certain amount of time or a duration beyond the threshold time. If the value of the capacitive change or the duration of the change does not exceed the specific threshold value, then the electric field sensor continues to monitor the electric field. Therefore, if a user inadvertently brushes past one of the input members, a signal may not result and false indications may be avoided, and control may return to block 112 to continue to monitor the electric field. If, however, the capacitive change level or duration does exceed the specific threshold value, then the signal is sent to the control circuitry as indicated block 118.

Once the signal has been sent, the control circuitry sends an electrical current to the solenoid to actuate the solenoid, opening the valve, as in block 120. Next, the air travels through the valve to open, as in block 122. In other embodiments though, other methods may be used to open the second valve.

While the embodiments above have been illustrated using a capacitive sensing method which is determined by generating an electric field and sensing disturbances in the electric field, a person skilled in the art will recognize that other sensing methods may be utilized in place of the electric fields in the embodiments shown. Other embodiments may utilize capacitive matrix sensing as well as other techniques and still be within the scope of the invention.

Moreover, in some embodiments, a normally closed solenoid valve may be a normally open solenoid valve, which therefore closes upon actuation, for example. Indeed, those of ordinary skill in the art may appreciate that whether actuation opens or closes a valve depends upon the structure and general setup, but actuation by both opening or closing are contemplated within the scope of the present invention. As such, valves (e.g., 62a and 62b) that open in the dental cuspidor may close, and the brake valve that closes in the dental delivery unit may open in some embodiments.

Furthermore, those of ordinary skill in the art may appreciate that the principles of the present invention may be utilized, for example, to replace a membrane button, purge at least one water line, replace a brake switch, etc. In particular, practically any switch may be replaced consistent with the principles of the present invention.

While the present invention has been illustrated by the description of the embodiments thereof, and while the embodiments have been described in considerable detail, it is not the intention of the application to restrict or in any way limit the scope of the appended claims to such detail. Additional advantages and modifications will readily appear to those skilled in the art. Therefore, the invention in its broader aspects is not limited to the specific details or representative devices and method, and illustrative examples shown and described. Accordingly, departures may be made form such details without departure from the spirit or scope of applicant's general inventive concept.

What is claimed is:

1. A dental or medical device comprising:
an electric field sensor having capacitive sensing and operable to detect a change in capacitance;
control circuitry in electronic communication with the electric field sensor, the control circuitry operable to receive a signal from the electric field sensor indicative of a detected change in capacitance; and
a solenoid in electronic communication with the control circuitry, wherein the control circuitry is operable to actuate the solenoid in response to receiving the signal from the electric field sensor.

2. The device of claim 1, wherein the solenoid is coupled with a valve, and wherein the solenoid opens or closes the valve in response to actuation of the solenoid by the control circuitry.

3. The device of claim 1, further comprising an input member disposed on the device and operable for controlling a function of the device.

4. The device of claim 3, wherein a capacitance change is generated when the input member is touched.

5. The device of claim 3, wherein the electric field sensor with capacitive sensing comprises:
a first layer on an external surface of the device, the first layer including the input member operable for controlling the function of the device; and
an electric field sensor layer disposed below the first layer, the electric field sensor providing a capacitive field proximate the first layer.

6. The device of claim 1, wherein the control circuitry is operable to actuate the solenoid for as long as the change in capacitance is detected by the electric field sensor.

7. The device of claim 6, wherein the control circuitry is operable to determine a length of time during which the change in capacitance is detected by the electric field sensor.

8. The device of claim 7, wherein the control circuitry is operable to actuate the solenoid for the determined length of time in response to any change in capacitance detected by the electric field sensor.

9. The device of claim 1, wherein the device is a dental cuspidor.

10. The device of claim 1, wherein the control circuitry includes a processor.

11. The device of claim 1, wherein the device is a dental delivery unit.

12. The device of claim 11, wherein actuating the solenoid of the dental delivery unit, the dental delivery unit operable to change from a braked state to a brake release state.

13. The device of claim 1, wherein a symbol is displayed proximate the input member indicating a function of the input member.

14. The device of claim 1, wherein the electric field sensor is further configured to register a touched condition when at least one of the capacitive change level or a duration exceeds a threshold value.

15. The device of claim 1, further comprising:
at least one other electric field sensor with capacitive sensing operable to detect a change in capacitance, and further operable to interact with the control circuitry to actuate the solenoid.

16. The device of claim 1, further comprising a touchpad disposed on the device, the touchpad comprising:
a screen disposed on the touchpad operable to display information associated with an apparatus coupled to the device of claim 1;
at least one button disposed on the touchpad, wherein the button facilitates navigation of the information.

17. The device of claim 1, wherein the touchpad further comprises:
at least one button disposed on the touchpad operable to control a function of an apparatus coupled to the device of claim 1.

18. A method for operating a device, the method comprising:
providing an input member for the device that controls a function of the device;
providing a capacitive field proximate to the first input member;
sensing a capacitive change in the capacitive field caused by the touch of a user; and
in response to the capacitive change, actuating a solenoid to perform the function.

19. The method of claim 19 further comprising:
providing a first layer on an external surface of the device;
providing the input member on the first layer; and
providing an electric field sensor layer disposed below the first layer, the electric field sensor layer providing a capacitive field proximate the first layer.

20. The method of claim 19 further comprising:
providing a second input member for the device that controls a different function of the device;
providing a capacitive field proximate to the second input member;
sensing a capacitive change in the capacitive field caused by the touch of a user; and
in response to the capacitive change, actuating the solenoid to perform the different function of the device.

21. The method of claim 19 further comprising:
providing a second input member for the device that controls a same function of the device;
providing a capacitive field proximate to the second input member;
sensing a capacitive change in the capacitive field caused by the touch of a user; and
in response to the capacitive change, actuating the solenoid to perform the function of the device.

22. A dental cuspidor comprising:
at least one electric field sensor having capacitive sensing and operable to detect a change in capacitance, wherein the electric field sensor is associated with a water dispensing function of the dental cuspidor, the electric field sensor comprising:
a first layer, including an input member operable for controlling the water dispensing function of the dental cuspidor, wherein the capacitance change is generated when the input member is touched; and
an electric field sensor layer disposed below the first layer;
control circuitry in electronic communication with the electric field sensor, the control circuitry operable to receive a signal from the electric field sensor indicative of a detected change in capacitance;
a solenoid in electronic communication with the control circuitry, wherein the control circuitry is operable to actuate the solenoid in response to receiving the signal from the electric field sensor;
a valve coupled to the solenoid, wherein the solenoid opens or closes the valve in response to actuation of the solenoid by the control circuitry; and
a water dispenser coupled to the valve, the water dispenser operable to dispense water in response to the opening or closing of the valve by the solenoid.

23. A dental delivery unit comprising:
at least one electric field sensor having capacitive sensing and operable to detect a change in capacitance, wherein the electric field sensor is associated with a brake release function of the dental delivery unit, the electric field sensor comprising:
a first layer, including an input member operable for controlling the brake release function of the dental delivery unit, wherein the capacitance change is generated when the first input member is touched; and
an electric field sensor layer disposed below the first layer;
control circuitry in electronic communication with the electric field sensor, the control circuitry operable to receive a signal from the electric field sensor indicative of a detected change in capacitance;
a solenoid in electronic communication with the control circuitry, wherein the control circuitry is operable to actuate the solenoid in response to receiving the signal from the electric field sensor;
a valve coupled to the solenoid, wherein the solenoid opens or closes the valve in response to actuation of the solenoid by the control circuitry; and
a brake coupled to the valve, the brake operable to release in response to the opening or closing of the valve by the solenoid.
